(19) United States
(12) Patent Application Publication
(10) Pub. No.: US 2005/0102366 A1
(43) Pub. Date: May 12, 2005

(54) E-mail filter employing adaptive ruleset

(76) Inventor: Steven T. Kirsch, Los Altos Hills, CA (US)

Correspondence Address: SCHNECK & SCHNECK, P.O. BOX 2-E, SAN JOSE, CA, 95109-0005, US

(21) Appl. No.: 10/703,844

(22) Filed: Nov. 7, 2003

(51) Int. Cl. G06F 15/16

(52) U.S. Cl. 709/207; 709/229

(57) ABSTRACT

An e-mail filter employing an adaptive ruleset for classifying received e-mail messages. The individual rules of the ruleset are applied to all or some received e-mail messages, depending on the configuration of the filter. In some embodiments, an initial rule or filter is applied to the message to obtain an initial rating indicating whether the recipient would want the message. Statistics collected for each rule in the ruleset are used to determine a weighted probability the message is wanted. A different weighted probability is obtained if the rule is satisfied or if the rule is not satisfied. A final probability the message is wanted is obtained after applying the filter's adaptive ruleset and using a weighted average to combine that score with any other rules and the message is processed accordingly. Statistics are updated using the machine-generated final probability, so the adaptive ruleset of the filter is constantly updated without requiring user input.

### FIELD OF THE INVENTION

This invention relates to software e-mail filters, especially those filters that employ adaptive rules to determine whether e-mail messages are wanted by the recipient.

### BACKGROUND OF THE INVENTION

The proliferation of junk e-mail, or “spam,” can be a major annoyance to e-mail users who are bombarded by unsolicited e-mails that clog up their mailboxes. While some e-mail solicitors do provide a link which allows the user to request not to receive e-mail messages from the solicitors again, many e-mail solicitors, or “spammers,” provide false addresses so that requests to opt out of receiving further e-mails have no effect as these requests are directed to addresses that either do no exist or belong to individuals or entities who have no connection to the spammer.

It is possible to filter e-mail messages using software that is associated with a user's e-mail program. In addition to message text, e-mail messages contain a header having routing information (including IP addresses), a sender's address, recipient's address, and a subject line, among other things. The information in the message header may be used to filter messages. One approach is to filter e-mails based on words that appear in the subject line of the message. For instance, an e-mail user could specify that all e-mail messages containing the word “mortgage” be deleted or posted to a file. An e-mail user can also request that all messages from a certain domain be deleted or placed in a separate folder, or that only messages from specified senders be sent to the user's mailbox. These approaches have limited success since spammers frequently use subject lines that do not indicate the subject matter of the message (subject lines such as “Hi” or “Your request for information” are common). In addition, spammers are capable of forging addresses, so limiting e-mails based solely on domains or e-mail addresses might not result in a decrease of junk mail and might filter out e-mails of actual interest to the user.

“Spam traps,” fabricated e-mail addresses that are placed on public websites, are another tool used to identify spammers. Many spammers “harvest” e-mail addresses by searching public websites for e-mail addresses, then send spam to these addresses. The senders of these messages are identified as spammers and messages from these senders are processed accordingly. More sophisticated filtering options are also available. For instance, Mailshell™ SpamCatcher works with a user's e-mail program such as Microsoft Outlook™ to filter e-mails by applying rules to identify and “blacklist” (i.e., identifying certain senders or content, etc., as spam) spam by computing a spam probability score. The Mailshell™ SpamCatcher Network creates a digital fingerprint of each received e-mail and compares the fingerprint to other fingerprints of e-mails received throughout the network to determine whether the received e-mail is spam. Each user's rating of a particular e-mail or sender may be provided to the network, where the user's ratings will be combined with other ratings from other network members to identify spam.

Mailfrontier™ Matador™ offers a plug-in that can be used with Microsoft Outlook™ to filter e-mail messages. Matador™ uses whitelists (which identify certain senders or content as being acceptable to the user), blacklists, scoring, community filters, and a challenge system (where an unrecognized sender of an e-mail message must reply to a message from the filtering software before the e-mail message is passed on to the recipient) to filter e-mails.

Cloudmark distributes SpamNet™, a software product that seeks to block spam. When a message is received, a hash or fingerprint of the content of the message is created and sent to a server. The server then checks other fingerprints of messages identified as spam and sent to the server to determine whether this message is spam. The user is then sent a confidence level indicating the server's “opinion” about whether the message is spam. If the fingerprint of the message exactly matches the fingerprint of another message in the server, then the message is spam and is removed from the user's inbox. Other users of SpamNet™ may report spam messages to the server. These users are rated for their trustworthiness and these messages are fingerprinted and, if the users are considered trustworthy, the reported messages blocked for other users in the SpamNet™ community.

SpamAssassin™ is another e-mail filter which uses a wide range of heuristic tests on mail headers and body text to try to block unsolicited e-mail. Unsolicited messages are detected based on scores of these tests.

A Bayesian filter may also be used, either on its own or in connection with one of the solutions discussed above. However, Bayesian filters require lots of training by each individual user before they can successfully detect and eliminate spam. In addition, Bayesian filters often focus on words alone, which may limit the filter's effectiveness since many words that are used in spam messages are also used in legitimate messages. In addition, Bayesian filters may be dilutive, in that not all words or terms in messages which are scanned by the filter are used in determining the probability the message is spam. For instance, one Bayesian filter (“Better Bayesian Filtering”, www.paulgraham.com/better.html, January 2003) proposed by Paul Graham uses only the fifteen most interesting “tokens” (text appearing in a message) to determine a probability the message is spam.

U.S. Pat. No. 6,161,130 to Horvitz et al. teaches an e-mail classifier which analyzes incoming messages' content to determine whether a message is “junk”. The classifier is trained on prior content classifications, i.e., features that are characteristic of junk or spam messages. Messages are probabilistically classified as legitimate or spam (though weighted probabilities are not used). The classifier may be retrained based on user input.

While current anti-spam solutions can be somewhat effective in eliminating spam, unsolicited messages often go undetected by these solutions. Part of the problem is that rules that current anti-spam solutions employ are static and therefore spammers can devise ways to get past the rules. Another problem is that most systems only give a rule significance if the rule is satisfied (for example, ten points are subtracted from a message's score if the rule is satisfied). However, rules can have significance if they are satisfied and also if they are not satisfied (example: subtract 10 if satisfied, add 5 if not satisfied) and a system that takes advantage of this could be quite powerful. Yet another drawback to some of these solutions is that they require lots of user input before they can effectively detect spam. An additional problem is that these solutions' message scores are often based on a trial and error approach rather than employing an accurate weighting system. Therefore, there is a need for an e-mail filter that employs dynamic scoring, gives rules significance if the rule is satisfied or not satisfied, does not require user input to be effective, and can precisely compute weights to give individual rules when assessing whether a received e-mail message is wanted or unsolicited.

### SUMMARY OF THE INVENTION

The need has been met by an e-mail filter employing an adaptive ruleset which is applied to e-mail messages to determine whether the messages are wanted. Statistics are tracked for each of the rules of the adaptive ruleset and are used to determine weighted probabilities, or scores, indicating the likelihood that received messages are wanted or unsolicited. A rule has significance when it is satisfied and when it is not satisfied. The statistics for each rule are updated each time a message is rated, so the weights and probabilities calculated for each rule are fine-tuned without user input. This e-mail filter may be particularly effective when combined with another rule or algorithm where a very accurate initial rating of the message is obtained.

In one embodiment, when an e-mail message is received, it is first given an initial rating by an initial rule or filter which is fairly accurate. (In other embodiments, no initial rating is obtained.) The adaptive ruleset is then applied to the e-mail message. (In some embodiments, the adaptive ruleset is only applied to messages which meet certain criteria (for instance, those messages which cannot accurately be classified by the initial rule).) A final probability the message is wanted is obtained (for instance, by averaging the weighted probabilities obtained using the adaptive ruleset with the initial rating or simply using the results obtained using the adaptive ruleset). The message is then processed accordingly (sent to the recipient's Inbox, sent to a spam folder, deleted, etc.).

### BRIEF DESCRIPTION OF THE DRAWINGS

FIG. 1a is a block diagram showing a network configuration of one embodiment of the invention.

FIG. 1b is a block diagram showing a network configuration of another embodiment of the invention.

FIG. 2 is a flowchart showing how the adaptive ruleset of the invention rates messages and is updated in one embodiment of the invention.

FIG. 3 is a flowchart showing how the adaptive ruleset of the invention rates messages and is updated is another embodiment of the invention.

### DETAILED DESCRIPTION OF THE INVENTION

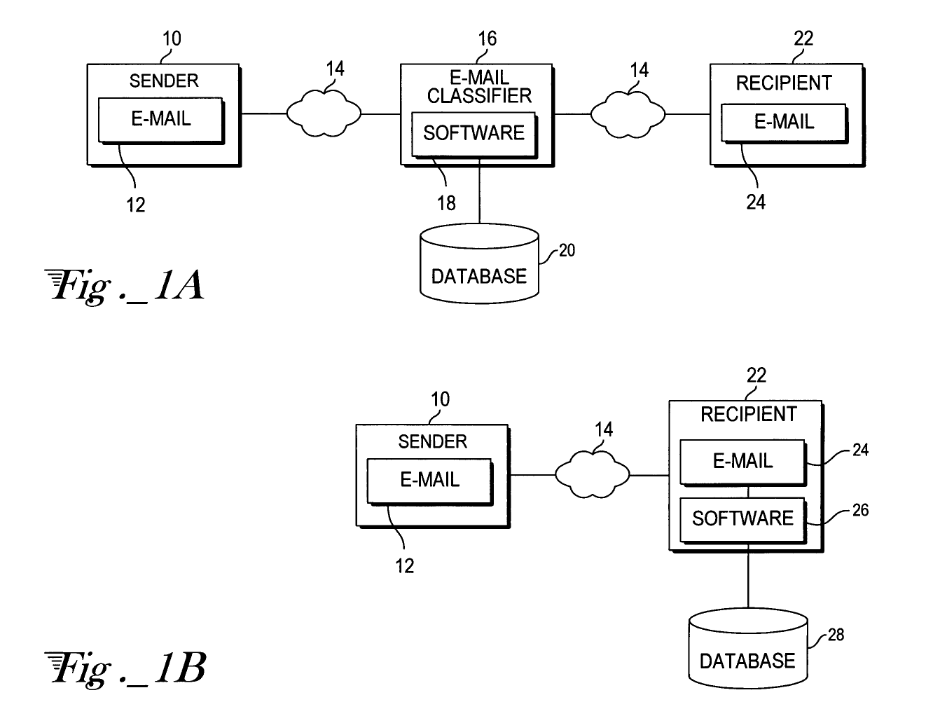

Referring to FIG. 1a, in one embodiment the e-mail filtering software 18 containing the ruleset for determining if an e-mail message is wanted by its intended recipient 22 may be running at a network device 16 intermediating between the sender 10 (which is running an e-mail software program 12, such as Microsoft Outlook™ or Qualcomm Eudora™) and the recipient 22 (also running an e-mail software program 24). The sender 10, network device 16, and recipient 22 are all in network connection 14 with each other. The network device 16 could be a device dedicated to classifying e-mail or may be any other network device such as an e-mail server. The filtering software 18 is associated with a database 20 for receiving, calculating, and storing statistics related to the ruleset, senders 10, and recipients 22. The database 20 may be running on the network device 16 or connected to the device 16 by a direct or network connection.

In FIG. 1b, the filtering software 26 containing the ruleset is running at the recipient 22 in another embodiment of the invention. The filtering software 26 is associated with the recipient's e-mail software 22. The database 28 for receiving, calculating, and storing statistics is associated with the filtering software 26 and may be running at the recipient or otherwise connected to the recipient 22, for instance by a direct or network connection.

In all embodiments of the invention, the filtering software may run on its own or may be used with other software filtering packages.

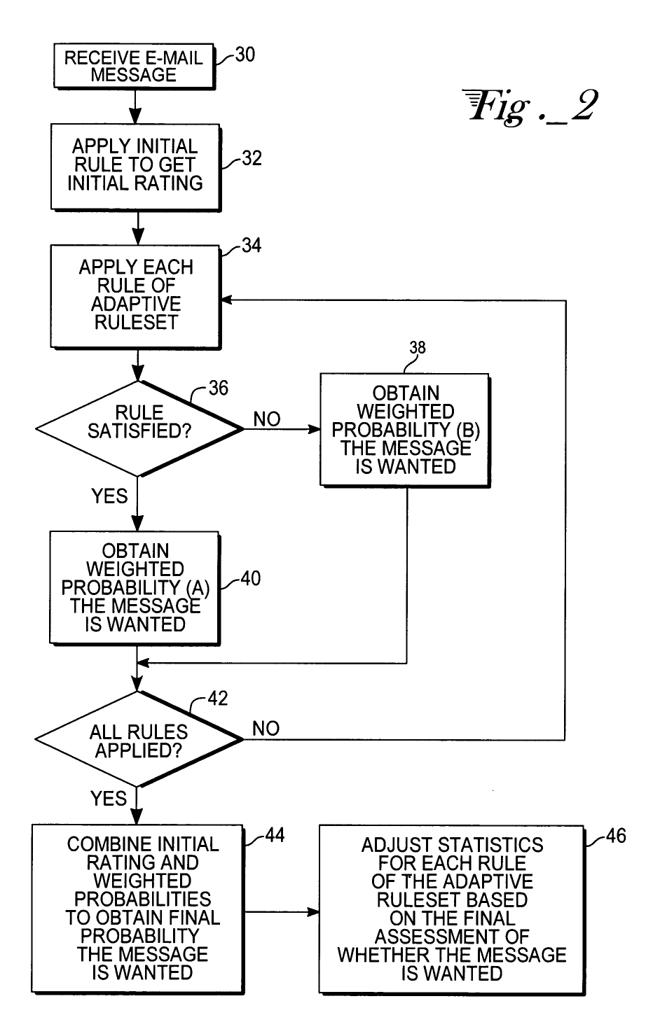

With reference to FIG. 2, in one embodiment of the invention, when an e-mail message is received (block 30) at either the network filtering device or the recipient (depending on where filtering is taking place), an initial rule is applied to obtain an initial rating of the e-mail message (block 32). This initial rule, or algorithm, ideally should be able to accurately (for instance, 95% or better, though a less effective initial rule may be employed) rate messages to determine whether they are wanted by the intended recipient or whether they are unwanted messages or “spam.” In other embodiments, a trained Bayes filter or any other mechanism may also be employed as an “initial rule” to obtain this initial rating. Multiple rules may also be applied to obtain an initial rating. The rating may be a score or some other value. Thresholds are set by a user or system administrator to determine what rating indicates a “good” (i.e., wanted) message or a “bad” (i.e., unwanted) message. Thresholds may also be set to determine ratings which indicate a message cannot be classified as good or bad.

Once the initial rating is obtained (block 32), each rule of the adaptive ruleset is applied to the e-mail message (block 34). Sample rules may include: 1) whether there are two consecutive spaces in the subject line and 2) whether there are more than four “non-English” words in the body. These rules are included for exemplary purposes; other embodiments may employ different rules for detecting wanted or unwanted messages in the ruleset. Rules may be added or deleted from the ruleset by the user or system administrator either on an individual basis or through software updates. If the rule is satisfied (block 36), a weighted probability, or score, that the message is wanted is obtained (block 40). If the rule is not satisfied (block 36), another weighted probability is obtained (block 38) since the rule may have different weights and probabilities depending on whether the rule is satisfied.

The weights and probabilities for each rule are based on statistics collected (at a database) for each rule of the adaptive ruleset as well as the initial rule. Statistics may be collected for both individual recipients or for all recipients in a network employing the adaptive ruleset. Statistics are collected for each rule in light of the initial ranking. For instance, for each rule the following statistics may be calculated:
p1=no. of good messages [as rated by the initial rule] which satisfy the current rule/total number of messages that satisfy the current rule
p2=no. of good messages [as rated by the initial rule] which don't satisfy the current rule/total number of messages that do not satisfy the current rule
p3=no. of good messages [as rated by the initial rule]/total number of messages rated by the initial rule.

If the message satisfies a rule, the weighted probability or score is |p1−p3|*p1. The weight of the rule is |p1−p3| and the probability of the rule is p1. If the message does not satisfy the rule, the weighted probability is |p2−p3|*p2. Here, the weight of the rule is |p2−p3| and the probability of the rule is p2.

In an alternative embodiment, other weights for each rule may be used. For instance, the weight of p1 could be (p1−p3)². The greater the difference between p3 and p1, the greater p1 should be weighted since the difference between p1 and p3 indicates the discriminatory power of the rule, i.e., whether p1 can differentiate the message as wanted or unwanted better than p3. (This method of weighting should also be consistently employed for the difference between p2 and p3.)

If a message is not helpful in differentiating wanted messages from unwanted messages, it will have a weight of zero or close to zero. For instance, suppose a rule is “message contains an odd number of characters.” Statistically, half of the messages received should satisfy the rule. Further suppose that 80% of received messages are unwanted. If 100 messages have been rated, p1=10/50, p2=10/50, and p3=20/100. Therefore, the weight of p1 would be |10/50−20/100| or 0 and the weight of p2 would be |10/50−20/100|, also 0. Since the rule does not differentiate between wanted messages and spam, the rule receives a weight of 0.

Returning again to FIG. 2, after the application of a rule (block 42), any remaining rules should also be applied (block 34). Once all the rules in the ruleset have been applied (block 42), a final probability of whether the message is wanted should be determined (block 44). This may be done by summing the weighted probabilities of each rule and dividing by the sum of weights for each rule. This result may then be combined with the initial rating in some fashion to obtain a final probability the message is wanted. For instance, the results from the adaptive ruleset may be averaged to obtain the final probability or some other weighted combination may be used. The results from the adaptive ruleset may also be used to determine the final probability without employing the initial rating.

The statistics for each rule are updated each time a message is rated (for instance, by adjusting counters of messages that are rated, the number of good messages satisfying the current rule, etc.) (block 46). Results of each rating of a message are sent to the database, where the statistics for each rule (example p1, p2, and p3) are updated. Due to this updating activity, the weights for each rule adapt to the incoming datastream without any user input.

In one embodiment of the invention, the adaptive ruleset may be used to rate the message without first obtaining an initial rating. In this embodiment, the adaptive ruleset could initially be given a set of starting values, for instance, values from another user who has been running the filter for a month or more. In this case, for each rule the values for p1, p2, and p3 could be as follows:
p1=no. good messages [as rated by the ruleset] that satisfy the rule/total no. of messages that satisfy the rule
p2=no. good messages [as rated by the ruleset] that don't satisfy the rule/total no. of messages that don't satisfy the rule
p3=no. good messages rated by the ruleset/total no. messages rated by the ruleset.

For each rule, the values p1, p2, and p3 are adjusted over time and the filter becomes better over time even though the user may never rate a single message.

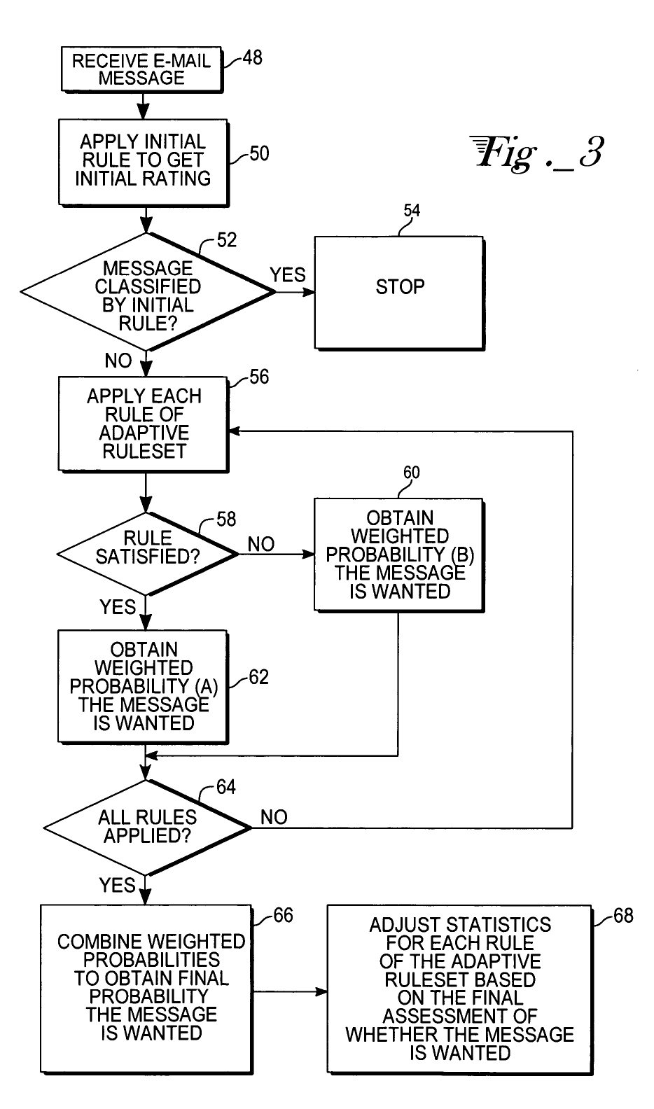

In another embodiment, the adaptive ruleset may be applied only to those messages which cannot be classified as good or bad by the initial rule. In other words, the ruleset only rates a portion of the messages sent to the recipient. For instance, if the initial rule can accurately rate 95% of messages received, the adaptive ruleset is applied to the remaining 5% of messages received. In FIG. 3, the e-mail message is received (block 48) and the initial rule is applied (block 50). If the message can be classified by the initial rule (block 52), the classification process for that particular message ends (block 54).

When the message cannot be classified by the initial rule (block 52), each rule of the adaptive ruleset is applied (block 56). The values for p1, p2, and p3 for each rule may be calculated as follows:
p1=no. good messages [as rated by the ruleset] that satisfy the rule/total no. of messages that satisfy the rule
p2=no. good messages [as rated by the ruleset] that don't satisfy the rule/total no. of messages that don't satisfy the rule
p3=no. good messages rated by the ruleset/total no. messages rated by the ruleset.
Weights and probabilities may be determined as discussed in FIG. 2, above. Returning to FIG. 3, different weighted probabilities are obtained (blocks 60, 62) for each message depending on whether the rule is satisfied (block 58).

Once a rule has been applied, a check is made to determine whether all rules have been applied (block 64). Once all the rules have been applied (block 64), the final probability that the message is wanted is obtained (block 66), for instance by summing the weighted probabilities obtained for each rule and dividing by the sum of the weights. The statistics for each rule of the adaptive ruleset are then updated as indicated above based on the final assessment of whether the message is wanted (block 68).

This embodiment is particularly useful for two reasons. First, since the adaptive ruleset is applied only to a portion of messages received, time and perhap s bandwidth (depending on whether the entire body of the message needs to be examined to classify it) are saved. Second, these initially unclassified messages may have completely different characteristics from those messages that can be classified by the initial rule. Therefore, the statistics for the rules in the adaptive ruleset are specifically related to that portion of the datastream that cannot be rated by the initial rule, as opposed to all messages sent to the recipient, and the adaptive ruleset will be extremely accurate when rating these messages.

In each of the embodiments, statistics for rules may be determined in different ways. In some embodiments, statistics are obtained based only on the application of the adaptive ruleset. In other embodiments, statistics may be obtained based on a combination of other rating algorithms (such as the initial rule(s)) which are employed with the adaptive ruleset to obtain a final probability the message is wanted.

In other embodiments, a moving average of statistics is maintained and used. More recently obtained statistics are weighted more than older statistics. For instance, when determining the moving average, the old value may be multiplied by a factor less than 1 and the new value is then added to the old value. Other embodiments may only use statistics collected and averaged over a certain time period, for example the last three months. These preferences may be set by a user or system administrator.

In each of these embodiments, thresholds may be set by a user or system administrator to determine a “good” or “bad” message depending on the final probability the message is wanted. For instance, a message may be considered “good” if the final probability the message is wanted is at least 0.90 or 90%. Those messages which are found to be good are passed on to the recipient (for instance, sent to the recipient's Inbox) while those messages that are bad are either sent to a spam folder or deleted, depending on the user's preferences. In each of the embodiments, the user can reverse the e-mail filter's rating by indicating that a message rated as good is actually unwanted and vice versa. If a rating decision is reversed, statistics are updated accordingly at the database.

1. In a communications network, a method for determining whether a received e-mail message is wanted comprising:
a) applying each rule of an adaptive ruleset to the message to obtain for each rule a weighted probability the message is wanted, wherein the weighted probability is based on statistics tracked for each rule;
b) determining a final probability the message is wanted based on the weighted probabilities obtained for each rule; and
c) adjusting statistics for each rule of the adaptive ruleset based on the final probability the message is wanted, wherein the adjustment does not require user input.

2. The method of claim 1 further comprising applying an initial rule to the message to determine an initial rating.

3. The method of claim 2 further comprising combining the initial rating with the final probability to assess whether the message is wanted.

4. The method of claim 3 wherein the initial rating and the final probability are averaged.

5. The method of claim 1 wherein the message receives a first weighted probability if the rule is satisfied and receives a second weighted probability if the rule is not satisfied.

6. The method of claim 1 further comprising storing statistics for each rule at a database.

7. The method of claim 1 further comprising setting a threshold based on the final probability to determine whether a message is wanted.

8. The method of claim 1 further comprising sending the message to the recipient if the message is wanted.

9. The method of claim 1 further comprising sending the message to a spam folder if the message is not wanted.

10. The method of claim 1 further comprising deleting the message if the message is not wanted.

11. The method of claim 2 further comprising applying each rule of the adaptive ruleset when the initial rating is not determinative of whether the message is wanted.

12. The method of claim 3 further comprising tracking statistics about the initial rule.

13. The method of claim 12 further comprising storing statistics at a database.

14. The method of claim 1 wherein the statistics for each rule are tracked for each user in the network.

15. The method of claim 1 further comprising maintaining and using a moving average of statistics tracked for each rule.

16. In a communications network, a method for providing and maintaining an adaptive ruleset used to determine whether received e-mail messages are wanted, the method comprising:
a) creating an adaptive ruleset of a plurality of rules to be applied to a received e-mail message to assess whether the e-mail message is wanted;
b) based on statistics, determining a weight and probability for each rule, the weight and probability to be used when assessing whether the e-mail message is wanted, wherein the weight and probability for each rule have different values when the rule is satisfied and when the rule is not satisfied; and
c) adjusting statistics for each rule of the adaptive ruleset each time the ruleset is applied to any received e-mail message, wherein the adjustment does not require user input.

17. The method of claim 16 further comprising storing statistics at a database.

18. The method of claim 16 wherein the weight for each rule is based on the rule's ability to differentiate a wanted message from an unwanted message.

19. The method of claim 16 wherein the adaptive ruleset is applied to every received e-mail message.

20. The method of claim 16 wherein the adaptive ruleset is applied only to those e-mail messages which cannot be classified by an initial rule.

21. The method of claim 16 wherein the statistics for each rule are tracked for each user in the network.

22. The method of claim 16 further comprising maintaining and using a moving average of statistics for each rule.

23. In a communications network, a system for classifying e-mail comprising:
a) a sender of an e-mail message;
b) an intended recipient of the e-mail message in network connection with the sender; and
c) an e-mail filter associated with the intended recipient for determining whether the message is wanted by the recipient and having means for:
i) applying each rule of an adaptive ruleset to the message to obtain for each rule a weighted probability the message is wanted, wherein the weighted probability is based on statistics tracked for each rule;
ii) determining a final probability the message is wanted based on the weighted probabilities obtained for each rule; and
iii) adjusting statistics for each rule of the adaptive ruleset based on the final probability the message is wanted, wherein the adjustment does not require user input.

24. The system of claim 23 further comprising a database associated with the filter for receiving, calculating, and storing statistics for the rules.

25. The system of claim 23 further comprising the filter having means for applying an initial rule to the message to determine an initial rating.

26. The system of claim 25 further comprising the filter having means for combining the initial rating with the final probability to assess whether the message is wanted.

27. The system of claim 26 further comprising the filter having means for averaging the initial rating and the final probability.

28. The system of claim 23 further comprising the filter having means for sending the message to the recipient if the message is wanted.

29. The system of claim 23 further comprising the filter having means for sending the message to a spam folder if the message is not wanted.

30. The system of claim 23 further comprising the filter having means for deleting the message if the message is not wanted.

31. The system of claim 25 further comprising the filter having means for applying each rule of the adaptive ruleset when the initial rating is not determinative of whether the message is wanted.

32. The system of claim 25 further comprising the filter having means for tracking statistics about the initial rule.

33. The system of claim 23 wherein the statistics for each rule are tracked for each recipient in the network.

34. The system of claim 23 further comprising the filter having means for maintaining and using a moving average of statistics for each rule.

35. A software-based adaptive ruleset for determining whether received e-mail messages are wanted comprising a plurality of rules, each of the rules to be applied to a received e-mail message to determine if the message is wanted, wherein, based on statistics collected for each rule, each rule has a weight and probability to be used to assess whether the message is wanted, wherein the weight and probability for each rule have different values when the rule is satisfied and when the rule is not satisfied, and the statistics determining the weight and probability for each rule are adjusted each time a rule is applied to any received e-mail message, wherein the adjustment does not require user input.

36. The adaptive ruleset for claim 35 wherein the weight for each rule is based on the rule's ability to differentiate a wanted message from an unwanted message.

37. The adaptive ruleset for claim 35 wherein the adaptive ruleset is applied to every received e-mail message.

38. The adaptive ruleset for claim 35 wherein the adaptive ruleset is applied only to those e-mail messages which cannot be classified by an initial rule.

39. The adaptive ruleset for claim 35 wherein the statistics are tracked for each user in the network.

40. The adaptive ruleset of claim 35 wherein a moving average of statistics is maintained and used.

41. A computer-readable storage medium storing instructions that, when executed by a computer, cause the computer to perform a method of determining whether a received e-mail message is wanted comprising:
a) applying each rule of an adaptive ruleset to the message to obtain for each rule a weighted probability the message is wanted, wherein the weighted probability is based on statistics tracked for each rule;
b) determining a final probability the message is wanted based on the weighted probabilities obtained for each rule; and
c) adjusting statistics for each rule of the adaptive ruleset based on the final probability the message is wanted, wherein the adjustment does not require user input.

42. The computer-readable storage medium of claim 41, the method further comprising applying an initial rule to the message to determine an initial rating.

43. The computer-readable storage medium of claim 42, the method further comprising combining the initial rating with the final probability to assess whether the message is wanted.

44. The computer-readable storage medium of claim 43 wherein the initial rating and the final probability are averaged.

45. The computer-readable storage medium of claim 41 wherein the message receives a first weighted probability if the rule is satisfied and receives a second weighted probability if the rule is not satisfied.

46. The computer-readable storage medium of claim 41, the method further comprising storing statistics for each rule at a database.

47. The computer-readable storage medium of claim 41, the method further comprising setting a threshold based on the final probability to determine whether a message is wanted.

48. The computer-readable storage medium of claim 41, the method further comprising sending the message to the recipient if the message is wanted.

49. The computer-readable storage medium of claim 41, the method further comprising sending the message to a spam folder if the message is not wanted.

50. The computer-readable storage medium of claim 41, the method further comprising deleting the message if the message is not wanted.

51. The computer-readable storage medium of claim 42, the method further comprising applying each rule of the adaptive ruleset when the initial rating is not determinative of whether the message is wanted.

52. The computer-readable storage medium of claim 43, the method further comprising tracking statistics about the initial rule.

53. The computer-readable storage medium of claim 52, the method further comprising storing statistics at a database.

54. The computer-readable storage medium of claim 41 wherein the statistics for each rule are tracked for each user in the network.

55. The computer-readable storage medium of claim 41, the method further comprising maintaining and using a moving average of statistics.
